(19) United States
(12) Patent Application Publication
(10) Pub. No.: US 2026/0184102 A1
(43) Pub. Date: Jul. 2, 2026

(54) Flip-Top Glue Stick Device

(71) Applicant: Andrea Bott, Kings Park, NY (US)

(72) Inventor: Andrea Bott, Kings Park, NY (US)

(21) Appl. No.: 19/289,158

(22) Filed: Aug. 4, 2025

Related U.S. Application Data
(60) Provisional application No. 63/739,893, filed on Dec. 30, 2024.

(51) Int. Cl. B43M 11/06; C09J 9/00

(52) U.S. Cl. CPC B43M 11/06; C09J 9/005

(57) ABSTRACT

A flip-top glue stick device is provided. The device is comprised of an integrated pivot-based cap assembly that allows for single-handed cap operation. More specifically, the device comprises a main body that may include grip-enhancing features such as molded ridges, indentations, or rubber overlays. The internal portion of the body includes an engagement member configured to support linear advancement of glue stick material via a spindle mechanism, which may be driven by rotation of a member at the lower end of the body. A cap assembly is pivotally connected to the body via a hinge, which may be a living hinge, pin-based, or other pivot structure, and includes a thumb tab with textured surfaces for enhanced actuation. The cap may be held in place by a latch interface.

### CROSS-REFERENCE TO RELATED APPLICATION

The present application claims priority to, and the benefit of, U.S. Provisional Application No. 63/739,893, which was filed on Dec. 30, 2024, and is incorporated herein by reference in its entirety.

### FIELD OF THE INVENTION

The present invention relates generally to the field of glue sticks. More specifically, the present invention relates to a glue stick having a spindle-driven glue stick mechanism and an integrated pivot-based cap assembly that enables single-handed operation of a cap. The hinged cap may further include a thumb tab for actuation and a latch interface for secure closure, allowing users to easily expose, apply, and reseal the adhesive material while minimizing residue buildup and drying. Accordingly, the present disclosure makes specific reference thereto. Nonetheless, it is to be appreciated that aspects of the present invention are also equally applicable to other like applications, devices, and methods of manufacture.

### BACKGROUND

Glue sticks are widely used in environments where children and individuals engage in creative or educational activities, such as homes, schools, daycares, libraries, and community centers. Traditional glue sticks are typically sealed using twist-on or pull-off caps that require a degree of grip strength and dexterity to operate. After use, glue residue often accumulates around the cap interface, causing the cap to adhere to the stick body and making subsequent removal difficult. This can result in product frustration, improper storage, or damage to the glue stick. For younger users and individuals with limited hand strength, these conventional caps present significant accessibility challenges. The risk of glue drying out due to improper resealing also contributes to product waste and inconsistent adhesive performance. Additionally, rolling of cylindrical glue sticks on flat surfaces can pose practical concerns, especially in shared or cluttered workspaces. These limitations reveal a broader issue in adhesive product design, where user ergonomics and functionality are not adequately addressed for all populations.

Therefore, there exists a long-felt need in the art for a flip-top glue stick device that facilitates easy, one-handed opening and closing of the cap without requiring twisting or pulling actions. There also exists a long-felt need in the art for a flip-top glue stick device that prevents the cap from becoming glued shut due to residual adhesive buildup. Moreover, there exists a long-felt need in the art for a flip-top glue stick device that improves accessibility for children and users with limited physical strength by enabling smoother and more intuitive cap operation.

The subject matter disclosed and claimed herein, in one embodiment thereof, comprises a flip-top glue stick device. The device is comprised of an integrated pivot-based cap assembly that allows for single-handed cap operation. More specifically, the device comprises a main body that may include grip-enhancing features such as molded ridges, indentations, or rubber overlays. The internal portion of the body includes an engagement member configured to support linear advancement of glue stick material via a spindle mechanism, which may be driven by rotation of a member at the lower end of the body. The glue stick material is supported on the spindle and may include functional additives such as colorants, glitter, or scent. A cap assembly is pivotally connected to the body via a hinge, which may be a living hinge, pin-based, or other pivot structure, and includes a thumb tab with textured surfaces for enhanced actuation. The cap may be held in place by a latch interface, which may use snap-fit, magnetic, or compression-based retention methods. The device enables application of adhesive material by exposing the glue through actuation of the cap, rotating the base to advance the glue, and securing the cap again post-use to minimize drying and contamination.

In this manner, the flip-top glue stick device of the present invention accomplishes all the foregoing objectives and provides a glue stick that eliminates the challenges associated with twist-off or pull-off lids. The integrated cap and latch assembly further mitigates glue residue buildup at the cap-body interface, thereby reducing the risk of accidental adhesion and stuck caps. The ergonomic grip features and one-handed actuation further enhance accessibility for children and individuals with limited strength or dexterity. By addressing usability, hygiene, and accessibility, the flip-top glue stick device provides a comprehensive solution to the longstanding issues present in conventional glue stick designs.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flip-top glue stick device. The device is designed to enhance glue stick usability by enabling single-handed operation through a flip-top cap mechanism, reducing manual effort, minimizing exposure to dried adhesive, and making the device suitable for children, individuals with limited hand strength, and high-use environments.

The device is comprised of a body, which preferably is cylindrical or tubular. The exterior surface may include grip-enhancing features such as indentations, rubber overmolds, or molded ridges. The interior space of the body may include an engagement member configured to facilitate linear displacement of the glue stick material. A support spindle further supports the glue stick material. A rotatable member, preferably positioned at the lower end of the body. The glue stick material may be a solid or semi-solid adhesive and may include additives such as glitter, fragrance, or UV-reactive compounds.

The cap assembly is comprised of a cap body pivotally attached to the body via at least one pivot point. The pivot point is preferably a living hinge. A latch interface may secure the cap in a closed position in one embodiment.

A method of use includes providing the device, pivoting the cap to expose the glue stick material, rotating the lower member to advance the glue stick, applying the adhesive to a surface, retracting the glue stick, and securing the cap to prevent drying or contamination.

Accordingly, the flip-top glue stick device of the present invention is particularly advantageous as it provides a glue stick that eliminates the challenges associated with twist-off or pull-off lids. The integrated cap and latch assembly further mitigates glue residue buildup at the cap-body interface, thereby reducing the risk of accidental adhesion and stuck caps. The ergonomic grip features and one-handed actuation further enhance accessibility for children and individuals with limited strength or dexterity. By addressing usability, hygiene, and accessibility, the flip-top glue stick device provides a comprehensive solution to the longstanding issues present in conventional glue stick designs. In this manner, the flip-top glue stick device overcomes the limitations of existing glue sticks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a flip-top glue stick device of the present invention with the cap assembly open in accordance with the disclosed architecture;

FIG. 2 illustrates a front view of one potential embodiment of a flip-top glue stick device of the present invention with the cap assembly closed in accordance with the disclosed architecture; and

FIG. 3 illustrates a flowchart of a method of using one potential embodiment of a flip-top glue stick device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a flip-top glue stick device that facilitates easy, one-handed opening and closing of the cap without requiring twisting or pulling actions. There also exists a long-felt need in the art for a flip-top glue stick device that prevents the cap from becoming glued shut due to residual adhesive buildup. Moreover, there exists a long-felt need in the art for a flip-top glue stick device that improves accessibility for children and users with limited physical strength by enabling smoother and more intuitive cap operation.

The present invention, in one exemplary embodiment, is comprised of a flip-top glue stick device. The device enhances glue stick functionality by allowing single-handed operation through a flip-top cap mechanism. The design further reduces manual effort, limits exposure to dried adhesive, and is well-suited for children, users with limited hand strength, and high-frequency usage environments.

The device is comprised of a body, preferably cylindrical or tubular in shape. Grip-enhancing elements may be integrated into the exterior surface of the body may be in the form of indentations, rubber overmolds, or molded ridges. The interior space may incorporate an engagement member configured to enable linear movement of the glue stick material. A support spindle is included to stabilize the adhesive material. A rotatable member further facilitates advancement of an adhesive material from the body. The material may be either solid or semi-solid and may include additives such as glitter, fragrance, or UV-reactive compounds.

The device is comprised of a cap assembly that includes a cap body that is pivotally connected to the body of the device through at least one pivot point, preferably utilizing a living hinge. In some configurations, a latch interface may be used to secure the cap in the closed position.

A method of operation involves providing the device, pivoting the cap to reveal the glue stick material, rotating the lower member to extend the adhesive, applying the glue to a surface, retracting the material, and closing the cap to prevent drying and contamination.

As a result, the flip-top glue stick device offers significant advantages by addressing the drawbacks associated with twist-off and pull-off lids. The integrated cap and latch mechanism further reduces glue residue accumulation at the cap-body junction, thereby minimizing the potential for accidental adhesion and stuck caps. In addition, the capability for single-handed use improves accessibility for children and users with limited dexterity. Therefore, the device effectively resolves common issues in conventional glue stick designs, offering a comprehensive improvement in usability, hygiene, and accessibility.

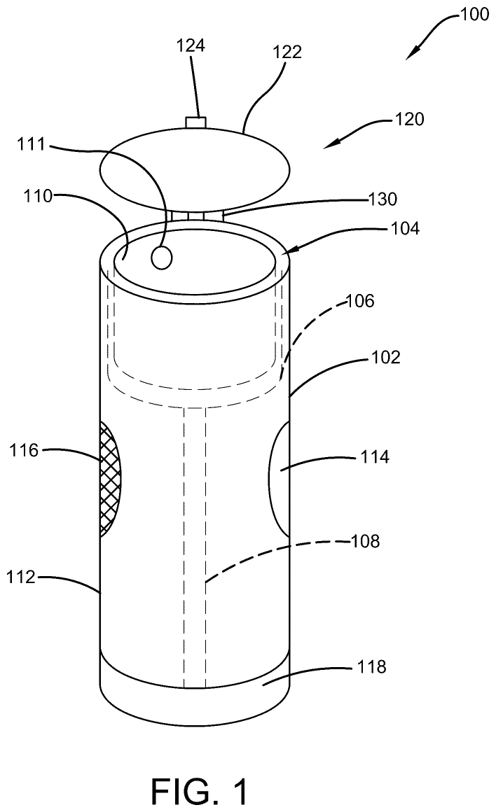

Referring initially to the drawings, FIG. 1 illustrates a front view of one potential embodiment of a flip-top glue stick device 100 of the present invention with the cap assembly 120 open in accordance with the disclosed architecture

The device 100 is designed to improve usability and accessibility of a glue stick by enabling single-handed operation through an integrated flip-top cap mechanism. This configuration minimizes the manual effort required to open and close the cap 122, reduces exposure to dried glue stick material 110, and is well suited for children, individuals with limited hand strength, and deployment in high-traffic or institutional settings such as classrooms, libraries, and creative workstations.

The device 100 may be comprised of a body 102. The body 102 is preferably cylindrical and may be tubular in shape, but in alternative embodiments, the body 102 may have polygonal profiles (e.g., triangular, square, hexagonal) to prevent rolling on flat surfaces. In one embodiment, an exterior surface 112 of the body 102 may incorporate grip-enhancing features such as indentations 114, surface texturing 116 in the form of rubber overmolds, molded ridges, etc.

The interior space 104 of the body 102 may include an engagement member 106 configured to facilitate linear displacement of the glue stick material 110 from the body 102, as seen in FIG. 1. The engagement member 106 may be comprised of a helically threaded sleeve, a pair of longitudinal guide rails, a cam-track configuration, etc. The support spindle 108 may be, but is not limited to, a screw-threaded rod, ratchet-driven column, or linear actuator that interfaces with the engagement member 106. The spindle 108 may be comprised of a receiving area 108 that receives and supports the glue stick material 110. The device 100 is further comprised of a rotatable member 118 that may be positioned at a lower end of the body 102 and configured to engage the support spindle 108. The member 118 may be comprised of a cylindrical disc, a ridged collar, or a hexagonal flange.

The glue stick material 110 may be comprised of a solid or semi-solid adhesive formulated from compounds such as, but not limited to, any combination of polyvinyl acetate (PVA), polyvinylpyrrolidone (PVP), dextrin, natural starches, and/or thermoplastic elastomers. In one variation, the glue stick material 110 may be color-tinted to indicate drying status, e.g., appearing a first color when applied and turning a second color (or clear) upon drying. In another configuration, the material 110 may include additives 111 such as glitter, fragrance, and/or UV-reactive compounds for novelty or educational applications.

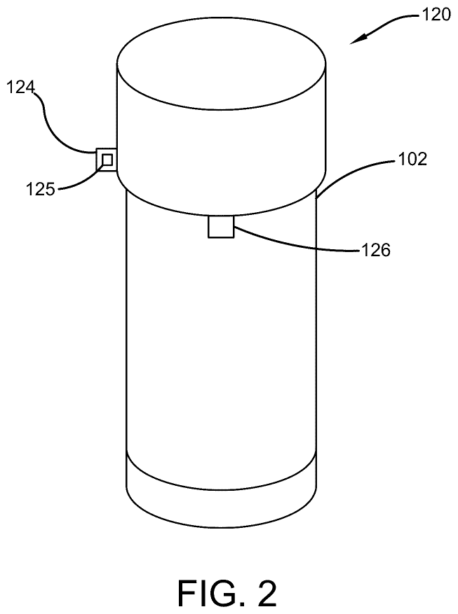

The cap assembly 120 may be comprised of a cap body 122 that is pivotally attached to the body 102 via at least one pivot point 130. The cap body 122 may be dome-shaped, semi-spherical, or angular in form. In one embodiment, the cap body 122 has a thumb tab 124 that may be positioned laterally or anteriorly relative to the hinge axis and may be shaped as a paddle, lever, wing element, etc., to enhance actuation. The thumb tab 124 may also incorporate an anti-slip surface grip area 125 in the form of micro-texturing or thermoplastic elastomer overlays, as seen in FIG. 2.

The pivot point 130 is preferably, but not limited to, comprised of a living hinge formed integrally between the cap body 122 and the body 102. In alternate embodiments, the pivot point 130 may be comprised of a mechanical hinge pin, torsional flex-joint, ball-and-socket element, etc. The pivot point 130 may support angular displacements in the range of 0 and 180 degrees, depending on the geometry of the cap 122 and body 102.

The device 100 may also be comprised of a latch interface 126 configured to secure the cap body 122 in a closed position relative to the body 102, as seen in FIG. 2. The latch interface 126 may be comprised of various engagement mechanisms such as, but not limited to, a snap-fit protrusion configured to deform elastically and engage a retention pocket, a magnetic clasp with embedded magnets or ferromagnetic elements to generate holding force, an elastic loop formed from elastomeric materials configured to stretch over a retention flange, or a compression fit socket that relies on interference between mating surfaces to maintain closure.

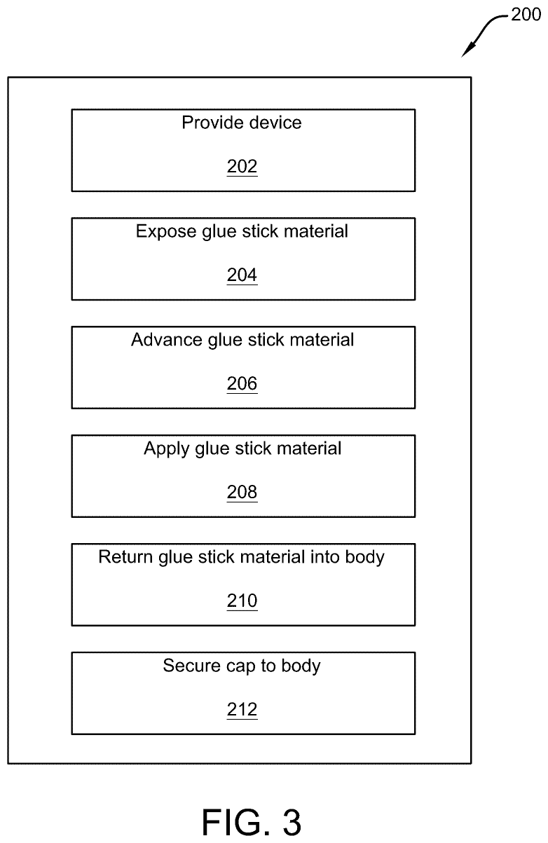

The present invention is also comprised of a method of using 200 the device 100, as seen in FIG. 3. First, a device 100 is provided comprised of a body 102, a glue stick material 110 supported by a support spindle 108, an engagement member 106 within an interior space 104 of the body 102, a rotatable member 118 positioned at a lower end of the body 102, and a cap assembly 120 comprised of a cap body 122 with a thumb tab 124 pivotally attached to the body 102 via a pivot point 130 and secured by a latch interface 126 [Step 202]. Then, a thumb tab 124 of the cap body 122 (if present) and/or the cap body 122 may be actuated using a single hand to pivot the cap body 122 about the pivot point 130 and expose the glue stick material 110 [Step 204]. Next, the rotatable member 118 can be rotated to linearly displace the support spindle 108 along the engagement member 106, thereby advancing the glue stick material 110 outward from the body 102 for application [Step 206]. Then, the glue stick material 110 may be applied to a target surface using direct contact [Step 208]. Then, the glue stick material 110 may be returned within the body 102 via rotating the member 118 [Step 210]. Finally, the cap body 122 can be pivoted back over the glue stick material 110 and secured to the body 102 using the latch interface 126 (if present) to prevent drying or contamination of the glue stick material 110 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flip-top glue stick device” and “device” are interchangeable and refer to the flip-top glue stick device 100 of the present invention.

Notwithstanding the foregoing, the flip-top glue stick device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the flip-top glue stick device 100 as shown in the FIGS. are for illustrative purposes only, and that many other sizes and shapes of the flip-top glue stick device 100 are well within the scope of the present disclosure. Although the dimensions of the flip-top glue stick device 100 are important design parameters for user convenience, the flip-top glue stick device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flip-top glue stick device comprising:
a body;
a support spindle positioned within the body and configured to support a glue stick material;
an engagement member positioned along an interior space of the body and configured to facilitate a linear displacement of the support spindle;
a rotatable member operatively connected to the support spindle; and
a cap assembly comprising a cap body pivotally attached to the body via a pivot point.

2. The flip-top glue stick device of claim 1, wherein the body is comprised of a polygonal body.

3. The flip-top glue stick device of claim 1, wherein an exterior surface of the body is comprised of an indentation.

4. The flip-top glue stick device of claim 1, wherein the engagement member is comprised of a threaded sleeve, a pair of guide rails, or a cam-track.

5. The flip-top glue stick device of claim 1, wherein the support spindle comprises a screw-threaded rod, a ratchet-driven column, or a linear actuator.

6. The flip-top glue stick device of claim 1, wherein the rotatable member is comprised of a cylindrical disc, a ridged collar, or a flange.

7. The flip-top glue stick device of claim 1, wherein the glue stick material is comprised of a solid adhesive material.

8. The flip-top glue stick device of claim 1, wherein the glue stick material is comprised of a fragrance.

9. A flip-top glue stick device comprising:
a body;
a support spindle positioned within the body and configured to support a glue stick material;
an engagement member positioned along an interior space of the body and configured to facilitate a linear displacement of the support spindle;
a rotatable member operatively connected to the support spindle; and
a cap assembly comprising a cap body pivotally attached to the body via a pivot point, and a thumb tab.

10. The flip-top glue stick device of claim 9, wherein an exterior surface of the body is comprised of a texturing.

11. The flip-top glue stick device of claim 9, wherein the engagement member is comprised of a threaded sleeve, a pair of guide rails, or a cam-track.

12. The flip-top glue stick device of claim 9, wherein the support spindle comprises a screw-threaded rod, a ratchet-driven column, or a linear actuator.

13. The flip-top glue stick device of claim 9, wherein the rotatable member is comprised of a cylindrical disc, a ridged collar, or a flange.

14. The flip-top glue stick device of claim 9, wherein the glue stick material is comprised of a semi-solid adhesive material.

15. The flip-top glue stick device of claim 9, wherein the glue stick material is comprised of a UV-reactive compound.

16. The flip-top glue stick device of claim 9, wherein the glue stick material is comprised of a glitter.

17. The flip-top glue stick device of claim 9, wherein the thumb tab is comprised of an anti-slip surface.

18. The flip-top glue stick device of claim 17, wherein the anti-slip surface is comprised of a micro-texturing.

19. The flip-top glue stick device of claim 17, wherein the anti-slip surface is comprised of a thermoplastic elastomer overlay.

20. A method of using a flip-top glue stick device, the method comprising the following steps:
providing a flip-top glue stick device comprised of a body, a glue stick material supported by a support spindle, an engagement member positioned along an interior space of the body, a rotatable member positioned at a lower end of the body, and a cap assembly comprising a cap body attached to the body via a pivot point;
actuating the cap body to pivot the cap body about the pivot point and expose the glue stick material;
rotating the rotatable member to linearly displace the support spindle along the engagement member and advance the glue stick material outward from the body;
applying the glue stick material to a target surface;
rotating the rotatable member to return the glue stick material within the body; and
pivoting the cap body back over the glue stick material and securing the cap body.
